(19) United States
(12) Patent Application Publication
(10) Pub. No.: US 2004/0064756 A1
(43) Pub. Date: Apr. 1, 2004

(54) Method and apparatus for improving reliability in computer processors by re-executing instructions

(76) Inventor: Sudarshan Kadambi, Hayward, CA (US)

Correspondence Address: PARK, VAUGHAN & FLEMING LLP, 508 SECOND STREET, SUITE 201, DAVIS, CA, 95616, US

(21) Appl. No.: 10/259,502

(22) Filed: Sep. 26, 2002

(51) Int. Cl. H04L 1/22

(52) U.S. Cl. 714/17

(57) ABSTRACT

One embodiment of the present invention provides a system that improves reliability in a compute processor by re-executing instructions. During operation, the system issues an instruction to an execution unit within the computer processor. The execution unit subsequently executes the instruction to produce a first result. If an idle execution slot becomes available, the system reissues the instruction to the execution unit, which causes the instruction to be executed a second time to produce a second result. The system then compares the first result with the second result. If the first result is not identical to the second result, the system flags an error.

### BACKGROUND

1. Field of the Invention

The present invention relates to techniques for improving reliability within computer processors. More specifically, the present invention relates to a method and an apparatus for improving reliability in computer processors by re-executing instructions during idle processor cycles.

2. Related Art

Dramatic improvements in computer system performance in recent years have largely been accomplished by decreasing the feature size of circuit elements within semiconductor chips. As feature size decreases, computer system designers are able to integrate larger numbers of circuit elements into a single semiconductor chip. Moreover, these smaller circuit elements are able to operate at lower switching voltages. This combination of smaller circuit elements and lower switching voltages makes it possible to switch circuit elements more rapidly, and this has dramatically increased the speed at which computer systems can operate.

Reducing the size of circuit elements and reducing switching voltage levels has reduced the number of electrons that are used to indicate a one or a zero value within a circuit element. As a result, phenomena such as cosmic ray hits and electromagnetic interference can easily change a value from zero to one or vice versa within a circuit element. Such phenomena are typically referred to as “single event upsets” and can seriously impact the operation of a computer system, in some cases causing an erroneous result, and in other cases causing the computer system to fail.

One technique that is used to remedy this problem involves running copies of the same program simultaneously on multiple processors. This makes it possible to detect and possibly correct an error by comparing the results produced by the different processors. While this approach is often effective at detecting errors, replicating portions of a computer system for fault-tolerance purposes is very expensive, and is typically justified in only the most critical applications—for example, in air and space applications where life is a stake.

Hence, what is needed is a method and an apparatus that provides fault tolerance within a computer system without the excessive cost involved in replicating portions of the computer system.

### SUMMARY

One embodiment of the present invention provides a system that improves reliability in a compute processor by re-executing instructions. During operation, the system issues an instruction to an execution unit within the computer processor. The execution unit subsequently executes the instruction to produce a first result. If an idle execution slot becomes available, the system reissues the instruction to the execution unit, which causes the instruction to be executed a second time to produce a second result. The system then compares the first result with the second result. If the first result is not identical to the second result, the system flags an error.

In a variation on this embodiment, reissuing the instruction involves selecting an oldest available instruction that has not yet been committed to an architectural state of the machine for reissue.

In a further variation, the system sets a flag to indicate that the instruction has been previously executed so that the instruction will not be re-executed.

In a further variation, the system writes the first result to a register file.

In a further variation, comparing the first result with the second result involves reading the first result from the register file and comparing the first result with the second result.

### BRIEF DESCRIPTION OF THE FIGURES

FIG. 1 illustrates the flow of an instruction through a processor in accordance with an embodiment of the present invention.

FIG. 2 illustrates an execution sequence in accordance with an embodiment of the present invention.

FIG. 3 is a flowchart illustrating the process of executing an instruction in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Processor

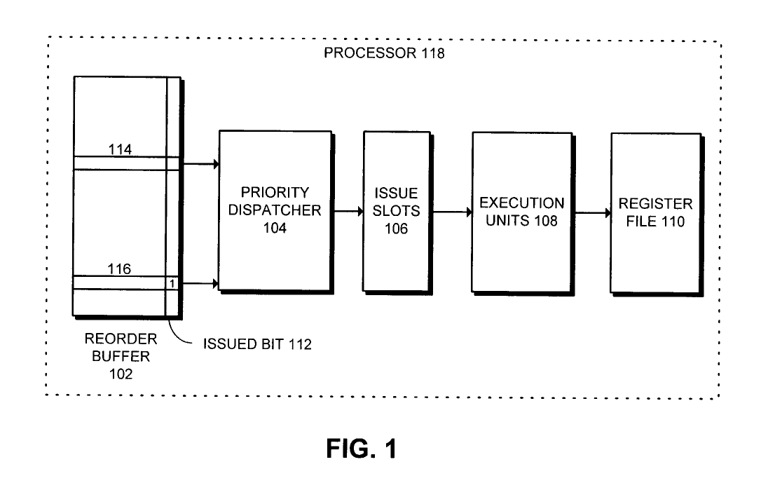

FIG. 1 illustrates a processor 118 in accordance with an embodiment of the present invention. Processor 118 can generally reside within any type of computer system, including, but not limited to, a computer system based on a microprocessor, a mainframe computer, a digital signal processor, a portable computing device, a personal organizer, a device controller, and a computational engine within an appliance. Processor 118 includes reorder buffer 102, priority dispatcher 104, issue slots 106, execution units 108, and register file 110. Reorder buffer 102 receives instructions to be scheduled for execution. These instructions can be instructions scheduled for issue or for reissue. Reorder buffer 102 includes issued bit 112, which indicates whether a particular instruction is an issue instruction or a reissue instruction. FIG. 1 shows two instructions in reorder buffer 102: instructions 114 and 116. Instruction 114 is an issue instruction and instruction 116 is a reissue instruction, as indicated by issued bit 112 being set for instruction 116 and not set for instruction 114.

Priority dispatcher 104 receives instruction issue requests from reorder buffer 102 to issue slots 106. Typically, issue slots 106 include six slots for issued instructions. When an issue slot is empty, priority dispatcher 104 selects an instruction from reorder buffer 102 for issue. If there is a non-reissued instruction available within reorder buffer 102, priority dispatcher 104 issues that instruction to issue slots 106. Otherwise, priority dispatcher 104 selects an instruction for issue, which has issued bit 112 set. Note that having issued bit 112 set indicates that the instruction is a reissue instruction. Priority dispatcher 104 then selects the oldest reissue instruction whose results have not been committed. Note that the system can alternatively reissue and re-execute all instructions; not just instructions that can make use of unused issue slots.

Execution units 108 execute the instructions from issue slots 106. If issued bit 112 is not set, execution units 108 write the results from the execution of the instruction into register file 110. However, if issued bit 112 is set, the system reads the previous results from register file 110 and compares the previous result with the current result. If the two values are not the same, the system flags an error.

Note that an error can be handled in many ways. For example, The results stored in register file 110 may be discarded, a hardware or software trap could be implemented, or the error could be logged for later analysis.

Execution Sequence

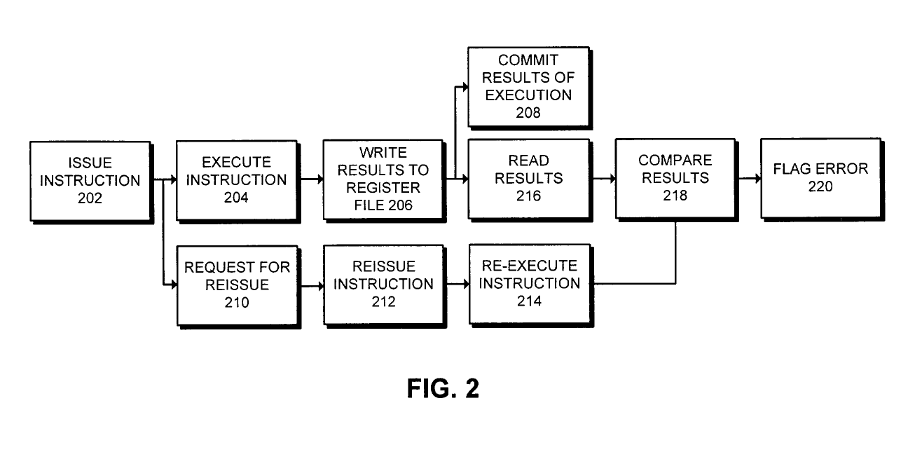

FIG. 2 illustrates an execution sequence in accordance with an embodiment of the present invention. The system starts when an instruction is issued (202) with idle slots available in priority dispatcher 104. Next, execution units 108 execute the instruction (204). A second path simultaneously requests for the reissue of the instruction (210). After execution units 108 finish executing the instruction, execution units 108 write the results to register file 110 (206). The second path, meanwhile, reissues the instruction (212). Execution units 108 then re-execute the instruction (214). While the execution units 108 re-execute the instruction, the system reads the result from register file 110 (216). The result from the re-execution is then compared against the results read from register file 110 (218). If the comparison indicates a difference, the system flags an error (220). Note that the system may commit the results of the first execution (208) at any time after the results are committed to register file 110. Executing an Instruction

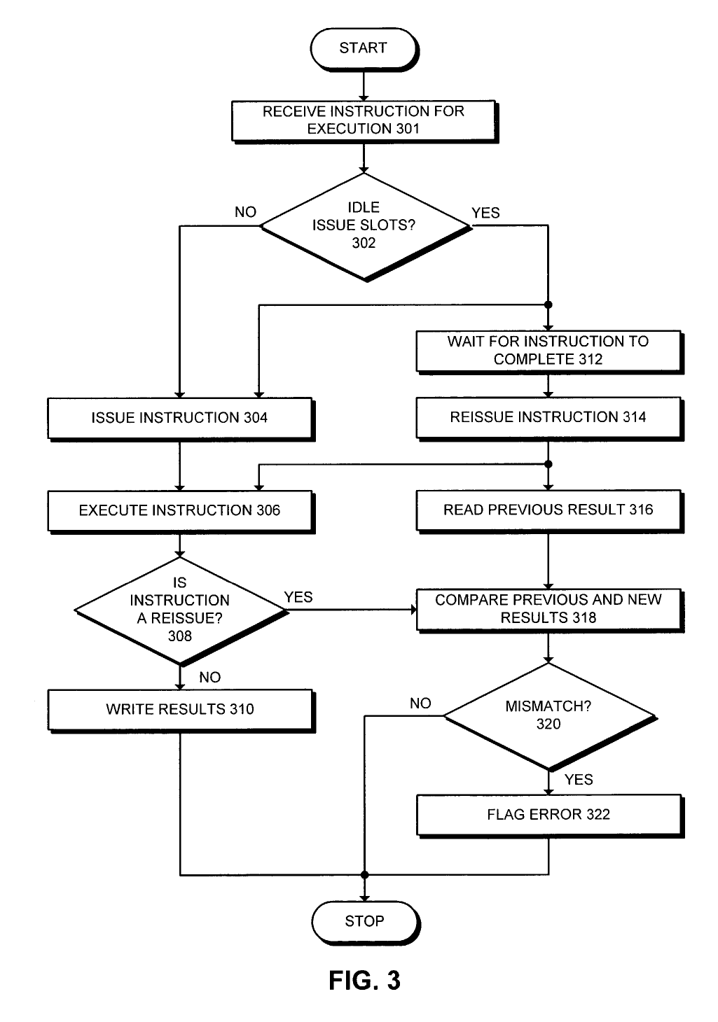

FIG. 3 is a flowchart illustrating the process of executing an instruction in accordance with an embodiment of the present invention. The system starts when an instruction is received for execution (step 301). Next, the system determines if there are idle issue slots available (step 302). If not, the system issues the instruction (step 304). After execution of the instruction (step 306), the system determines if the instruction is a reissue instruction (step 308). Since this is the first time the instruction has been executed, it is not a reissue instruction. Hence, the system writes the results to the register file terminating the process (step 310).

If there are idle issue slots available at step 302, the system enables two paths of execution. In the first path, the system issues the instruction (step 304) while the second path waits for the execution of the instruction to complete (step 312). The first path proceeds as above through steps 306, 308, and 310 finally writing the result of the execution into register file 110.

After the instruction has been executed through the first path, the second path reissues the instruction (step 314). This causes the execution unit to re-execute the instruction (step 306). Next, the system determines if this is a reissue instruction (step 308). Since this is a reissue instruction, control passes to step 318. Meanwhile, the second path has read the previous result from the register file (step 316). Next, the system compares the previous result and the new result (step 318). The system then determines if there is a mismatch between the results (step 320). If so, the system flags an error (step 322). Otherwise, the process is complete.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method that verifies results produced during execution of computer instructions, comprising:
issuing an instruction to an execution unit;
executing the instruction in the execution unit to produce a first result; and
if an idle execution slot is available,
reissuing the instruction to the execution unit,
executing the instruction a second time to produce a second result,
comparing the first result with the second result, and
if the first result is not identical to the second result, flagging an error.

2. The method of claim 1, wherein reissuing the instruction involves selecting an oldest available instruction that has not yet been committed to an architectural state of the machine for reissue.

3. The method of claim 1, further comprising setting a flag, whereby the flag indicates that the instruction has been previously executed so that the instruction will not be re-executed.

4. The method of claim 1, further comprising writing the first result to a register file.

5. The method of claim 4, wherein comparing the first result with the second result involves:
reading the first result from the register file; and
comparing the first result and the second result.

6. An apparatus that verifies results produced during execution of computer instructions, comprising:
an issuing mechanism that is configured to issue an instruction to an execution unit;
an instruction execution unit that is configured to execute the instruction to provide a first result;
a determining mechanism that is configured to determine if an idle execution slot is available;
a reissuing mechanism that is configured to reissue the instruction to the execution unit;
wherein the instruction execution unit is further configured to re-execute the instruction to provide a second result;
a comparing mechanism that is configured to compare the first result with the second result; and
a flagging mechanism that is configured to flag an error if the first result is not identical to the second result.

7. The apparatus of claim 6, further comprising a selecting mechanism that is configured to select an oldest available instruction that has not yet been committed to an architectural state of the machine for reissue.

8. The apparatus of claim 6, further comprising a setting mechanism that is configured to set a flag, whereby the flag indicates that the instruction has been previously executed so that the instruction will not be re-executed.

9. The apparatus of claim 6, further comprising a writing mechanism that is configured to write the first result to a register file.

10. The apparatus of claim 9, further comprising a reading mechanism that is configured to read the first result from the register file, wherein the comparing mechanism is further configured to compare the first result and the second result.

11. A computer processor that executes a method that verifies results produced during execution of computer instructions, the method comprising:
issuing an instruction to an execution unit;
executing the instruction in the execution unit to produce a first result; and
if an idle execution slot is available,
reissuing the instruction to the execution unit,
executing the instruction a second time to produce a second result,
comparing the first result with the second result, and
if the first result is not identical to the second result, flagging an error.

12. The computer processor of claim 11, wherein reissuing the instruction involves selecting an oldest available instruction that has not yet been committed to an architectural state of the machine for reissue.

13. The computer processor of claim 11, the method further comprising setting a flag, whereby the flag indicates that the instruction has been previously executed so that the instruction will not be re-executed.

14. The computer processor of claim 11, the method further comprising writing the first result to a register file.

15. The computer processor of claim 14, wherein comparing the first result with the second result involves:
reading the first result from the register file; and
comparing the first result and the second result.

16. A computer system including a processor that executes a method that verifies results produced during execution of computer instructions, the method comprising:
issuing an instruction to an execution unit;
executing the instruction in the execution unit to produce a first result; and
if an idle execution slot is available,
reissuing the instruction to the execution unit,
executing the instruction a second time to produce a second result,
comparing the first result with the second result, and if the first result is not identical to the second result, flagging an error.

17. The computer system of claim 16, wherein reissuing the instruction involves selecting an oldest available instruction that has not yet been committed to an architectural state of the machine for reissue.

18. The computer system of claim 16, the method further comprising setting a flag, whereby the flag indicates that the instruction has been previously executed so that the instruction will not be re-executed.

19. The computer system of claim 16, the method further comprising writing the first result to a register file.

20. The computer system of claim 19, wherein comparing the first result with the second result involves:
reading the first result from the register file; and
comparing the first result and the second result.
